(19) United States
(12) Patent Application Publication
(10) Pub. No.: US 2007/0240790 A1
(43) Pub. Date: Oct. 18, 2007

(54) Rare-earth sintered magnet and method for producing the same

(76) Inventors: Teruyoshi Kita, Saitama (JP); Haruhiko Shimizu, Saitama (JP); Takayuki Higashi, Saitama (JP); Shigeki Muroga, Saitama (JP); Futoshi Kuniyoshi, Osaka (JP); Yuji Kaneko, Osaka (JP); Akihito Tsujimoto, Osaka (JP)

Correspondence Address: NEOMAX CO., LTD.;C/O KEATING & BENNETT, LLP, 8180 GREENSBORO DRIVE, SUITE 850, MCLEAN, VA, 22102, US

(21) Appl. No.: 11/236,708

(22) Filed: Sep. 26, 2005

(30) Foreign Application Priority Data
Sep. 27, 2004 (JP) 2004-278840

(51) Int. Cl. H01F 1/057

(52) U.S. Cl. 148/105; 148/302

(57) ABSTRACT

A rare-earth sintered magnet according to the present invention includes: 28.5 mass % to 32.0 mass % of R, which includes Tb and at least one of the other rare-earth elements; 0.91 mass % to 1.15 mass % of B; at most 0.35 mass % of oxygen; and Fe with or without Co and inevitably contained impurities as the balance. The magnet includes 3.2 mass % to 5.2 mass % of Tb, and has a remanence Bᵣ of at least 1.29 T, a coercivity H_{cJ} of at least 2.4 MA/m and a maximum energy product (BH)ₘₐₓ of at least 320 kJ/m³.

### BACKGROUND OF THE INVENTION

1. Field of the Invention

The present invention relates to a rare-earth sintered magnet with high magnetic properties including a remanence Bᵣ of at least 1.29 T, a coercivity H_{cJ} of at least 2.4 MA/m and a maximum energy product (BH)ₘₐₓ of at least 320 kJ/m³, which can be used very effectively to make a motor, and also relates to a method for producing such a magnet.

2. Description of the Related Art

An R—Fe—B based permanent magnet, which is a typical high-performance permanent magnet as disclosed in Japanese Patent Application Laid-Open Publication No. 59-46008, for example, has such excellent magnetic properties as to have found a wide variety of applications including various types of motors and actuators. Also, to modify the magnet performance to varying degrees according to those applications, R—Fe—B based permanent magnets with lots of different compositions have been proposed so far.

However, as there is still a growing demand to further reduce the sizes and weights of, and further enhance the performances of, various types of electrical and electronic devices, R—Fe—B based permanent magnets for use in those devices are increasingly required to improve their performances.

For that purpose, according to a conventional technique of making a high-performance R—Fe—B based permanent magnet as disclosed in Japanese Patent Gazette for Opposition No. 5-10807, for example, they try to improve the magnetic properties (e.g., the coercivity H_{cJ} among other things) by adding a heavy rare-earth element such as Dy, Tb, Gd, Ho, Er, Tm or Yb to the rare-earth element R.

In order to improve the performances of R—Fe—B based permanent magnets, various compositions, including the one disclosed in Japanese Patent Gazette for Opposition No. 5-10807, have been proposed. However, nobody has ever succeeded in providing an R—Fe—B based permanent magnet with excellent magnetic properties including a remanence Bᵣ of at least 1.29 T, a coercivity H_{cJ} of at least 2.4 MA/m and a maximum energy product (BH)ₘₐₓ of at least 320 kJ/m³, which can be used effectively to make a motor.

### SUMMARY OF THE INVENTION

In order to overcome the problems described above, a primary object of the present invention is to provide a rare-earth sintered magnet with excellent magnetic properties including a remanence Bᵣ of at least 1.29 T, a coercivity H_{cJ} of at least 2.4 MA/m and a maximum energy product (BH)ₘₐₓ of at least 320 kJ/m³, which can be used effectively to make a motor, and also provide a method for producing such a magnet.

As a result of extensive researches, the present inventors discovered that this object could be achieved by adopting the following composition.

A rare-earth sintered magnet according to the present invention includes: 28.5 mass % to 32.0 mass % of R, which includes Tb and at least one of the other rare-earth elements; 0.91 mass % to 1.15 mass % of B; at most 0.35 mass % of oxygen; and Fe with or without Co and inevitably contained impurities as the balance. The magnet includes 3.2 mass % to 5.2 mass % of Tb, and has a remanence Bᵣ of at least 1.29 T, a coercivity H_{cJ} of at least 2.4 MA/m and a maximum energy product (BH)ₘₐₓ of at least 320 kJ/m³.

In one preferred embodiment of the present invention, the magnet includes at most 0.05 mass % of Si and at most 0.08 mass % of Mn.

In another preferred embodiment, the magnet includes at most 0.45 mass % of La, at most 0.4 mass % of Ce, at most 0.05 mass % of Sm and at most 0.1 mass % of Y.

In still another preferred embodiment, the magnet includes at most 0.02 mass % of Ca, at most 0.02 mass % of Mg and at most 0.02 mass % of Ti.

In yet another preferred embodiment, the magnet includes 30.5 mass % to 31.5 mass % of R.

In yet another preferred embodiment, the magnet includes 4.5 mass % to 5.0 mass % of Tb.

In yet another preferred embodiment, the magnet includes 0.94 mass % to 1.06 mass % of B.

In yet another preferred embodiment, the magnet includes at most 0.25 mass % of oxygen.

In yet another preferred embodiment, the magnet includes at most 0.10 mass % of carbon.

In yet another preferred embodiment, R includes 4.5 mass % to 5.0 mass % of Tb, and the balance of R includes Nd and at least one of the rare-earth elements other than Tb and Nd as inevitably contained impurities.

A method for producing a rare-earth sintered magnet according to the present invention includes the steps of: melting and casting a material metal or alloy to obtain alloy cast flakes; pulverizing the alloy cast flakes to make a coarsely pulverized powder; subjecting the coarsely pulverized powder to a jet mill pulverization process within an inert gas atmosphere including 200 ppm or less of oxygen, thereby making a finely pulverized powder; and compacting the finely pulverized powder under a magnetic field and then subjecting a resultant green compact to a sintering process and a heat treatment, thereby obtaining a rare-earth sintered magnet. The rare-earth sintered magnet includes: 28.5 mass % to 32.0 mass % of R, which includes 3.2 mass % to 5.2 mass % of Tb and at least one of the other rare-earth elements; 0.91 mass % to 1.15 mass % of B; at most 0.35 mass % of oxygen; and Fe with or without Co and inevitably contained impurities as the balance. And the magnet has a remanence Bᵣ of at least 1.29 T, a coercivity H_{cJ} of at least 2.4 MA/m and a maximum energy product (BH)ₘₐₓ of at least 320 kJ/m³.

In one preferred embodiment of the present invention, the finely pulverized powder has a mean particle size of 2.0 μm to 2.7 μm.

In another preferred embodiment, the step of compacting the finely pulverized powder includes applying a pulse magnetic field with a strength of 2.0 T or more.

In still another preferred embodiment, the step of compacting includes loading a mold with the finely pulverized powder, sealing the mold, aligning the powder with a magnetic field applied thereto, and then subjecting the powder to a cold isostatic pressing process.

In yet another preferred embodiment, the step of aligning includes aligning the powder with a pulse magnetic field with a strength of 2.0 T or more.

The present invention provides a rare-earth sintered magnet with excellent magnetic properties including a remanence Bᵣ of at least 1.29 T, a coercivity H_{cJ} of at least 2.4 MA/m and a maximum energy product (BH)ₘₐₓ of at least 320 kJ/m³, which can be used effectively to make a motor.

In addition, the present invention also provides a method for producing such a rare-earth sintered magnet efficiently.

### DETAILED DESCRIPTION OF PREFERRED EMBODIMENTS

Hereinafter, it will be described why the composition mentioned above is preferred for the rare-earth sintered magnet of the present invention.

R includes Tb and at least one of the other rare-earth elements. That is to say, Tb is an essential element for R but any other rare-earth element may be included in R. Tb preferably accounts for 3.5 mass % to 5.5 mass % of the entire magnet. Meanwhile, R including Tb preferably accounts for 28.5 mass % to 32.0 mass % of the entire magnet. The reasons are as follows. Specifically, if the content of R were less than 28.5 mass %, it would be difficult to advance the sintering process to such a point as to achieve desired high coercivity H_{cJ}. On the other hand, if the content of R exceeded 32.0 mass %, then the remanence Bᵣ would decrease significantly. A more preferred range of the R content is 30.5 mass % to 31.5 mass %. By making the R content fall within this range, the remanence Bᵣ and/or coercivity H_{cJ} can be further increased.

The at least one rare-earth element other than Tb preferably includes Nd with or without Pr. The reasons are as follows. Specifically, Pr can increase the coercivity effectively at ordinary temperatures but may decrease the coercivity significantly at high temperatures. That is why Pr should not be included in profusion. However, Pr is usually included in a didymium alloy (i.e., an Nd—Pr alloy), which is less expensive than metal Nd with high purity. Considering the coercivity at high temperatures, R ideally consists essentially of Tb and Nd. In that case, however, expensive high-purity Nd would have to be used. For that reason, to provide a rare-earth sintered magnet at a reasonable price, the addition of an appropriate amount of Pr should be permitted.

Optionally, the at least one rare-earth element other than Tb may include Dy. The greater the amount of Dy added, the higher the coercivity of the resultant rare-earth sintered magnet would be. However, it is known that the remanence decreases inversely proportionally to the increase in coercivity. According to the present invention, Tb is preferably partially replaced with those elements so as to realize the desired high magnetic properties including a Bᵣ of at least 1.29 T, an H_{cJ} of at least 2.4 MA/m and a (BH)ₘₐₓ of at least 320 kJ/m³, which can be used very effectively to make a motor.

The content of Tb is preferably 3.2 mass % to 5.2 mass %. This is because the desired high coercivity would not be achieved if the content of Tb were less than 3.2 mass % and because the remanence would decrease if the content of Tb exceeded 5.2 mass %. A more preferable range of the Tb content is 4.5 mass % to 5.0 mass %. By making the Tb content fall within this range, Bᵣ or H_{cJ} can be increased. If R includes 4.5 mass % to 5.0 mass % of Tb and if the balance of R includes Nd and at least one of the rare-earth elements other than Tb and Nd as inevitably contained impurities, of which the content falls within the range specified above, then even higher magnetic properties are realized.

The rare-earth elements R such as Tb and Nd do not have to be pure elements, but may include some impurities, which will be inevitably contained during the manufacturing process, as long as such impure elements are available on an industrial basis. However, in a high performance rare-earth sintered magnet with excellent magnetic properties including a Bᵣ of at least 1.29 T, an H_{cJ} of at least 2.4 MA/m and a (BH)ₘₐₓ of at least 320 kJ/m³, which can be used very effectively to make a motor just like the magnet of the present invention, even a very small amount of rare-earth elements as impurities may deteriorate the magnetic properties. For that reason, the purity of R is preferably defined such that the magnet includes at most 0.45 mass % of La, at most 0.4 mass % of Ce, at most 0.05 mass % of Sm and at most 0.1 mass % of Y.

The content of B is preferably 0.91 mass % to 1.15 mass %. This is because the desired high coercivity would not be achieved if the B content were less than 0.91 mass % and because the remanence would decrease if the B content were more than 1.15 mass %. A more preferable B range is 0.94 mass % to 1.06 mass %, in which Bᵣ and/or H_{cJ} can be increased.

The content of oxygen preferably has an upper limit of 0.35 mass % because the coercivity and remanence would decrease if the content of oxygen exceeded 0.35 mass %. The upper limit of a more preferable oxygen range is 0.25 mass %, under which Bᵣ or H_{cJ} can be increased.

The balance of the magnet, other than Pr, R and B, preferably includes Fe with or without Co. Up to 50% of Fe may be replaced with Co. Also, the magnet may further include small amounts of transition metal elements other than Fe and Co. Co is effective in improving the temperature characteristics and corrosion resistance. However, if an excessive amount of Co were added, then the coercivity would decrease. That is why the rest of the magnet preferably includes, in combination, 10 mass % or less of Co and Fe as the balance. More particularly, the rest is preferably a combination of 0.85 mass % to 0.95 mass % of Co and Fe as the balance.

If the magnet includes not only these essential elements but also an additional element M, which is at least one element selected from the group consisting of Al, V, Ni, Cu, Zn, Zr, Nb, Mo, In, Ga, Sn, Hf, Ta and W, then the coercivity can be increased. The content of the additional element M is preferably 2.0 mass % or less. This is because the remanence would decrease if the M content exceeded 2.0 mass %. Particularly, if the rare-earth sintered magnet of the present invention includes 0.15 mass % to 0.25 mass % of Al and 0.05 mass % to 0.15 mass % of Cu, the magnetic properties can be further improved. Al and Cu may be added as impurities included in iron or ferroboron. However, it is more preferable that Al and Cu are added separately and controlled to the contents specified above.

Si and Mn, which will be contained as impurities of iron or ferroboron, deteriorate the magnetic properties as their content increases. For that reason, the purity of the materials is preferably defined so as to control the content of Si to 0.05 mass % or less and the content of Mn to 0.08 mass % or less. Not just Si and Mn but also Ca, Mg and Ti would affect the high magnetic properties of the rare-earth sintered magnet of the present invention. That is why the purity of the materials is preferably defined so as to control the contents of Ca, Mg and Ti in the impurities to 0.02 mass % or less each.

Furthermore, carbon is also one of the factors that would deteriorate the magnetic properties. Thus, the content of carbon in the rare-earth sintered magnet is preferably controlled to 0.10 mass % or less. Carbon is not only contained in the material itself but also happen to be introduced during the manufacturing process. For that reason, a manufacturing process that can eliminate the unintentional introduction of carbon as much as possible, e.g., a jet mill pulverization process to be described later, is preferred.

By adopting such a composition, a rare-earth sintered magnet with excellent magnetic properties, including a Bᵣ of at least 1.29 T, an H_{cJ} of at least 2.4 MA/m and a (BH)ₘₐₓ of at least 320 kJ/m³, which can be used very effectively to make a motor, can be obtained. The rare-earth sintered magnet of the present invention is characterized by its composition. Thus, the manufacturing process thereof does not particularly limit the scope of the present invention. Nevertheless, by adopting the manufacturing process to be described below, the rare-earth sintered magnet of the present invention can be produced efficiently.

In the first process step, a material metal or alloy is melted and cast to obtain alloy cast flakes. The melting and casting processes may be carried out by known techniques. Among other things, a strip casting process is particularly preferred.

In the next process step, the alloy cast flakes are pulverized to make a coarsely pulverized powder. The coarsely pulverized powder may also be obtained by any known technique.

Subsequently, the coarsely pulverized powder is subjected to a jet mill pulverization process within an inert gas atmosphere including 200 ppm or less of oxygen, thereby making a finely pulverized powder. If the concentration of oxygen exceeded 200 ppm, then the content of oxygen in the finely pulverized powder would increase excessively and the content of oxygen in the resultant sintered magnet would exceed 0.35 mass %, which is not beneficial. Nitrogen or argon gas may be used as the inert gas. The jet mill may also be a known machine.

The finely pulverized powder preferably has a mean particle size of 2.0 μm to 2.7 μm. The reason is as follows. Specifically, if the mean particle size of the finely pulverized powder were less than 2.0 μm, then the concentration of oxygen in the finely pulverized powder would increase excessively. However, if the mean particle size of the finely pulverized powder were more than 2.7 μm, then the coercivity would decrease significantly.

After the fine pulverization process is finished, a known compaction process under a magnetic field, a known sintering process and a known heat treatment process may be carried out as respective process steps. It is particularly effective to adopt the following methods.

The compaction process under the magnetic field is preferably carried out by applying a pulse magnetic field with a field strength of 2.0 T or more. Then, Bᵣ of the rare-earth sintered magnet can be increased.

After the finely pulverized powder has been loaded into a mold, sealed and then aligned with a magnetic field applied, the compaction process may be carried out as a cold isostatic pressing process. Then, the remanence of the rare-earth sintered magnet can be further increased. If the magnetic field aligning process is carried out under a pulse magnetic field with a field strength of at least 2.0 T, then the remanence can be further raised.

### EXAMPLES

### Example 1 (How to Define Tb Content)

An alloy, of which the composition was represented by the general formula Nd_{24.5-x}TbₓPr_{6.0}B_{1.0}Co_{0.9}Fe (where the content x of Tb was changed in the order of 3.0, 3.2, 3.8, 4.5, 5.0, 5.2 and 5.5, Fe is the balance of the alloy including inevitably contained impurities and all contents are expressed in mass percentages), was melted. The molten alloy was rapidly quenched and solidified by a strip casting process, thereby obtaining alloy cast flakes. These alloy cast flakes were coarsely pulverized by a hydrogen pulverization process and a dehydrogenation process. Thereafter, the resultant coarsely pulverized powder was subjected to a jet mill pulverization process within a nitrogen atmosphere including 100 ppm of oxygen, thereby obtaining a finely pulverized powder with a mean particle size of 2.3 μm.

Next, the finely pulverized powder thus obtained was loaded into a die, aligned with a static magnetic field with a field strength of 0.8 T and then compacted. The resultant compact was sintered at 1,333 K for two hours and then subjected to a heat treatment at 823 K for one hour, thereby obtaining a sintered magnet. Each sintered magnet included 0.25 mass % of oxygen and 0.08 mass % of carbon. Analyzing the composition of each sintered magnet, the impurities thereof included at most 0.05 mass % of Si, at most 0.08 mass % of Mn, at most 0.45 mass % of La, at most 0.4 mass % of Ce, at most 0.05 mass % of Sm, at most 0.1 mass % of Y, at most 0.02 mass % of Ca, at most 0.02 mass % of Mg and at most 0.02 mass % of Ti. This sintered magnet further included 0.20 mass % of Al and 0.10 mass % of Cu.

The magnetic properties of the sintered magnets obtained in this manner are shown in the following Table 1, in which the samples with * are comparative examples where x=3.0 and x=5.5, respectively. As can be seen from Table 1, if the content of Tb was less than 3.2 mass %, then H_{cJ} decreased to less than 2.4 MA/m. However, if the content of Tb was more than 5.2 mass %, then Bᵣ decreased to less than 1.29 T. As a result, (BH)ₘₐₓ was lower than 320 kJ/m³. Taking these results into consideration, the content of Tb was defined as 3.2 mass % to 5.2 mass %. Also, as is clear from Table 1, the best magnetic properties were realized when the content of Tb was in the range of 4.5 mass % to 5.0 mass %.

TABLE 1

| Sample | Tb content | Bᵣ | H_{cJ} | (BH)ₘₐₓ |
|---|---|---|---|---|
| No. | (mass %) | (T) | (MA/m) | (kJ/m³) |
| 1* | 3.0 | 1.340 | 2.33 | 346 |
| 2 | 3.2 | 1.329 | 2.40 | 340 |
| 3 | 3.8 | 1.317 | 2.45 | 334 |
| 4 | 4.5 | 1.305 | 2.52 | 328 |
| 5 | 5.0 | 1.298 | 2.55 | 324 |
| 6 | 5.2 | 1.290 | 2.61 | 320 |
| 7* | 5.5 | 1.281 | 2.68 | 316 |

### Example 2 (How to Define R Content)

Sintered magnets were produced as in the first specific example described above except that an alloy, of which the composition was represented by Nd_{y}Tb_{4.5}Pr_{6.0}B_{1.0}Co_{0.9}Fe (where the content y of Nd was changed in the order of 17.0, 18.0, 19.0, 20.0, 21.0, and 22.0, the overall content of R (=Nd+Tb+Dy) was changed in the order of 27.5, 28.5, 29.5, 30.5, 31.5 and 32.5, Fe is the balance of the alloy including inevitably contained impurities and all contents are expressed in mass percentages), was used. Each of those sintered magnets included 0.25 mass % of oxygen. The sintered magnets of this specific example included similar amounts of carbon, Al, Cu and impurities as compared to the counterparts of the first specific example.

The magnetic properties of the sintered magnets obtained in this manner are shown in the following Table 2, in which the samples with * are comparative examples where y was 17.0 and content of R was 27.5 and where y was 22.0 and content of R was 32.5, respectively. As can be seen from Table 2, if the overall content of R was less than 28.5 mass %, then the magnet could not be sintered sufficiently. However, if the overall content of R was more than 32.0 mass %, then Bᵣ decreased to less than 1.29 T. As a result, (BH)ₘₐₓ was lower than 320 kJ/m³. Taking these results into consideration, the overall content of R was defined as 28.5 mass % to 32.0 mass %. Also, as is clear from Table 2, the best magnetic properties were realized when the overall content of R was in the range of 30.5 mass % to 31.5 mass %.

TABLE 2

| Sample | R content | Bᵣ | H_{cJ} | (BH)ₘₐₓ |
|---|---|---|---|---|
| No. | (mass %) | (T) | (MA/m) | (kJ/m³) |
| 8* | 27.5 | NA | NA | NA |
| 9 | 28.5 | 1.339 | 2.46 | 345 |
| 10 | 29.5 | 1.322 | 2.49 | 337 |
| 11 | 30.5 | 1.305 | 2.52 | 328 |
| 12 | 31.5 | 1.291 | 2.53 | 321 |
| 13* | 32.5 | 1.274 | 2.55 | 313 |

### Example 3 (How to Define B Content)

Sintered magnets were produced as in the first specific example described above except that an alloy, of which the composition was represented by Nd_{20.0}Tb_{4.5}Pr_{6.0}B_{z}Co_{0.9}Fe (where the content z of B was changed in the order of 0.89, 0.94, 1.00, 1.06 and 1.16, Fe is the balance of the alloy including inevitably contained impurities and all contents are expressed in mass percentages), was used. Each of those sintered magnets included 0.25 mass % of oxygen. The sintered magnets of this specific example included similar amounts of carbon, Al, Cu and impurities as compared to the counterparts of the first specific example.

The magnetic properties of the sintered magnets obtained in this manner are shown in the following Table 3, in which the samples with * are comparative examples where z was 0.89 and where z was 1.16, respectively. As can be seen from Table 3, if the content of B was less than 0.91 mass %, then H_{cJ} decreased to less than 2.4 MA/m. However, if the content of B was more than 1.15 mass %, then Bᵣ decreased to less than 1.29 T. Taking these results into consideration, the content of B was defined as 0.91 mass % to 1.15 mass %. Also, as is clear from Table 3, the best magnetic properties were realized when the content of B was in the range of 0.94 mass % to 1.06 mass %.

TABLE 3

| Sample | B content | Bᵣ | H_{cJ} | (BH)ₘₐₓ |
|---|---|---|---|---|
| No. | (mass %) | (T) | (MA/m) | (kJ/m³) |
| 14* | 0.89 | 1.323 | 1.10 | 337 |
| 15 | 0.94 | 1.316 | 2.48 | 334 |
| 16 | 1.00 | 1.305 | 2.52 | 328 |
| 17 | 1.06 | 1.301 | 2.52 | 326 |
| 18* | 1.16 | 1.288 | 2.53 | 320 |

### Example 4 (How on Define Oxygen Concentration)

An alloy, of which the composition was represented by Nd_{20.0}Tb_{4.5}Pr_{6.0}B_{1.0}Co_{0.9}Fe (where Fe is the balance of the alloy including inevitably contained impurities and all contents are expressed in mass percentages), was melted. The molten alloy was rapidly quenched and solidified by a strip casting process, thereby obtaining alloy cast flakes. These alloy cast flakes were coarsely pulverized by a hydrogen pulverization process and a dehydrogenation process. Thereafter, the resultant coarsely pulverized powder was subjected to a jet mill pulverization process within a nitrogen atmosphere including 100 ppm of oxygen, a nitrogen atmosphere including 200 ppm of oxygen, a nitrogen atmosphere including 1,000 ppm of oxygen, and a nitrogen atmosphere including 3,000 ppm of oxygen, thereby obtaining finely pulverized powders with a mean particle size of 2.3 μm. The finely pulverized powders obtained in this manner were compacted, sintered and subjected to a heat treatment as in the first specific example described above to obtain sintered magnets.

The oxygen concentrations and magnetic properties of the sintered magnets obtained in this manner are shown in the following Table 4, in which the samples with * are comparative examples where the oxygen concentration were 0.40 mass % and 0.55 mass %, respectively. As can be seen from Table 4, once the oxygen concentration exceeded 0.35 mass %, Bᵣ, H_{cJ} and (BH)ₘₐₓ all decreased. Among other things, the decrease in coercivity H_{cJ} was significant. And when the oxygen concentration further increased, the sintering process could not be carried out anymore. Taking these results into consideration, the oxygen concentration was defined as 0.35 mass % or less. Also, as is clear from Table 4, better magnetic properties were realized when the oxygen concentration was 0.25 mass %.

As also can be seen from Table 4, when the flow rate of oxygen introduced during the jet mill pulverization process was increased, the concentration of oxygen in the sintered magnet increased. Furthermore, to reduce the concentration of oxygen in the sintered magnet to 0.35 mass % or less, the flow rate of oxygen introduced during the jet mill pulverization process had to be 200 ppm or less. That is why the flow rate of oxygen introduced during the jet mill pulverization process was defined as 200 ppm or less.

TABLE 4

| | O₂ flow | | O₂ | | | |
|---|---|---|---|---|---|---|
| Sample | rate during | | concentration | Bᵣ | H_{cJ} | (BH)ₘₐₓ |
| No. | jet milling | | (mass %) | (T) | (MA/m) | (kJ/m³) |
| 19 | 100 | ppm | 0.25 | 1.305 | 2.52 | 328 |
| 20 | 200 | ppm | 0.35 | 1.304 | 2.50 | 327 |
| 21* | 1,000 | ppm | 0.40 | 1.290 | 2.20 | 320 |
| 22* | 3,000 | ppm | 0.55 | NA | NA | NA |

### Example 5 (How to Define Mean Particle Size)

An alloy, of which the composition was represented by Nd_{20.0}Tb_{4.5}Pr_{6.0}B_{1.0}Co_{0.9}Fe (where Fe is the balance of the alloy including inevitably contained impurities and all contents are expressed in mass percentages), was melted. The molten alloy was rapidly quenched and solidified by a strip casting process, thereby obtaining alloy cast flakes. These alloy cast flakes were coarsely pulverized by a hydrogen pulverization process and y a dehydrogenation process. Thereafter, the resultant coarsely pulverized powder was subjected to a jet mill pulverization process within a nitrogen atmosphere with various amounts of the coarsely pulverized powder introduced, thereby obtaining finely pulverized powders with the mean particle sizes shown in the following Table 5. The finely pulverized powders obtained in this manner were compacted, sintered and subjected to a heat treatment as in the first specific example described above to obtain sintered magnets.

The oxygen concentrations and magnetic properties of the sintered magnets obtained in this manner are shown in the following Table 5. As can be seen from Table 5, the smaller the mean particle size, the higher the concentration of oxygen included in the sintered magnet. When the mean particle size was 1.8 μm, the oxygen concentration was too high to carry out the sintering process. Meanwhile, as the mean particle size increases, the oxygen concentration decreases but the magnetic properties (the coercivity H_{cJ} among other things) deteriorate as well. That is why the finely pulverized powder preferably has a mean particle size of 2.0 μm to 2.7 μm. However, as the preferable range is also changeable with the flow rate of oxygen introduced during the jet mill pulverization process, the best conditions of the jet mill pulverization process are preferably determined appropriately.

TABLE 5

| | Mean | O₂ | | | |
|---|---|---|---|---|---|
| Sample | particle | concentration | Bᵣ | H_{cJ} | (BH)ₘₐₓ |
| No. | size (μm) | (mass %) | (T) | (MA/m) | (kJ/m³) |
| 23 | 1.80 | 0.50 | NA | NA | NA |
| 24 | 2.00 | 0.30 | 1.300 | 2.55 | 325 |
| 25 | 2.30 | 0.25 | 1.305 | 2.52 | 328 |
| 26 | 2.70 | 0.23 | 1.306 | 2.45 | 328 |
| 27 | 3.30 | 0.21 | 1.303 | 2.40 | 327 |
| 28 | 3.50 | 0.21 | 1.301 | 2.30 | 326 |

### Example 6 (Die Compaction Under Pulse Magnetic Field)

An alloy, of which the composition was represented by Nd_{20.0}Tb_{4.5}Pr_{6.0}B_{1.0}Co_{0.9}Fe (where Fe is the balance of the alloy including inevitably contained impurities and all contents are expressed in mass percentages), was melted. The molten alloy was rapidly quenched and solidified by a strip casting process, thereby obtaining alloy cast flakes. These alloy cast flakes were coarsely pulverized by a hydrogen pulverization process and a dehydrogenation process. Thereafter, the resultant coarsely pulverized powder was subjected to a jet mill pulverization process within a nitrogen atmosphere with an oxygen concentration of 100 ppm, thereby obtaining a finely pulverized powder with a mean particle size of 2.3 μm.

Next, the finely pulverized powder thus obtained was loaded into a die, aligned with a pulse magnetic field with a field strength of 2.0 T or 3.5 T and then compacted. The resultant compact was sintered at 1,333 K for two hours and then subjected to a heat treatment at 823 K for one hour, thereby obtaining a sintered magnet. Each sintered magnet included 0.25 mass % of oxygen.

The magnetic properties of the sintered magnets obtained in this manner are shown in the following Table 6, which also shows the results of an example in which the finely pulverized powder was aligned with a static magnetic field with a field strength of 0.8 T (i.e., Sample No. 31 corresponding to Sample No. 4 of Example No. 1) for reference. As can be seen from Table 6, the finely pulverized powder aligned with a pulse magnetic field of 2.0 T or more exhibited significantly increased Bᵣ and (BH)ₘₐₓ than the finely pulverized powder aligned with a static magnetic field with a field strength of 0.8 T. It can also be seen that Bᵣ and (BH)ₘₐₓ further increased when the strength of the pulse magnetic field was raised. Consequently, to increase Bᵣ and (BH)ₘₐₓ, the compaction process under the magnetic field is preferably carried out under a pulse magnetic field with a field strength of 2.0 T or more.

TABLE 6

| | Field | | | |
|---|---|---|---|---|
| Sample | strength | Bᵣ | H_{cJ} | (BH)ₘₐₓ |
| No. | (T) | (T) | (MA/m) | (kJ/m³) |
| 29 | 2.0 | 1.312 | 2.50 | 332 |
| 30 | 3.5 | 1.315 | 2.50 | 333 |
| 31 | 0.8 | 1.305 | 2.52 | 328 |

### Example 7 (CIP Process Under Pulse Magnetic Field)

An alloy, of which the composition was represented by Nd_{20.0}Tb_{4.5}Pr_{6.0}B_{1.0}Co_{0.9}Fe (where Fe is the balance of the alloy including inevitably contained impurities and all contents are expressed in mass percentages), was melted, quenched and pulverized by the same methods as those adopted in the first specific example, thereby obtaining a finely pulverized powder with a mean particle size of 2.3 μm. The finely pulverized powder thus obtained was loaded into a rubber mold with a diameter of 25 mm and a height of 25 mm so as to have a fill density of 3.5 g/cm³ and then the rubber mold was sealed with a rubber cap. Next, a pulse magnetic field with a field strength of 2.0 T or 3.5 T was applied to this rubber mold, thereby aligning the powder.

Subsequently, the aligned rubber mold was compacted by a cold isostatic pressing (CIP) process. After that, the rubber mold was removed to unload the green compact. Then, this compact was sintered at 1,333 K for two hours and then subjected to a heat treatment at 823 K for one hour, thereby obtaining a sintered magnet. Each sintered magnet included 0.25 mass % of oxygen.

The magnetic properties of the sintered magnets obtained in this manner are shown in the following Table 7, which also shows the magnetic properties of a sample in which the finely pulverized powder was put into a die, not the rubber mold, aligned with a magnetic field applied, and then compacted (i.e., Sample No. 34 corresponding to Sample No. 4 of Example No. 1) for reference. As can be seen from Table 7, the finely pulverized powder that was loaded into a mold, sealed, aligned with a pulse magnetic field applied, and then subjected to a cold isostatic pressing process exhibited slightly lower coercivity H_{cJ}, but significantly higher Bᵣ and (BH)ₘₐₓ, than the finely pulverized powder that was put into a die, aligned with a magnetic field applied and then compacted. It can also be seen that Bᵣ and (BH)ₘₐₓ further increased when the strength of the pulse magnetic field was raised. Consequently, to increase Bᵣ and (BH)ₘₐₓ, the finely pulverized powder is preferably loaded into a mold, sealed, aligned with a pulse magnetic field applied and then subjected to a cold isostatic pressing process and the strength of the pulse magnetic field is preferably 2.0 T or more.

TABLE 7

| | Field | | | |
|---|---|---|---|---|
| Sample | strength | Bᵣ | H_{cJ} | (BH)ₘₐₓ |
| No. | (T) | (T) | (MA/m) | (kJ/m³) |
| 32 | 2.0 | 1.317 | 2.50 | 334 |
| 33 | 3.5 | 1.322 | 2.48 | 337 |
| 34 | 0.8 | 1.305 | 2.52 | 328 |

A rare-earth sintered magnet according to the present invention has excellent magnetic properties, including a remanence Bᵣ of at least 1.29 T, a coercivity H_{cJ} of at least 2.4 MA/m and a maximum energy product (BH)ₘₐₓ of at least 320 kJ/m³, and therefore, can be used very effectively to make a motor.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A rare-earth sintered magnet comprising:
28.5 mass % to 32.0 mass % of R, which includes Tb and at least one of the other rare-earth elements;
0.91 mass % to 1.15 mass % of B;
at most 0.35 mass % of oxygen; and
Fe with or without Co and inevitably contained impurities as the balance,
wherein the magnet includes 3.2 mass % to 5.2 mass % of Tb, and
wherein the magnet has a remanence Bᵣ of at least 1.29 T, a coercivity H_{cJ} of at least 2.4 MA/m and a maximum energy product (BH)ₘₐₓ of at least 320 kJ/m³.

2. The rare-earth sintered magnet of claim 1, comprising at most 0.05 mass % of Si and at most 0.08 mass % of Mn.

3. The rare-earth sintered magnet of claim 1, comprising at most 0.45 mass % of La, at most 0.4 mass % of Ce, at most 0.05 mass % of Sm and at most 0.1 mass % of Y.

4. The rare-earth sintered magnet of claim 1, comprising at most 0.02 mass % of Ca, at most 0.02 mass % of Mg and at most 0.02 mass % of Ti.

5. The rare-earth sintered magnet of claim 1, comprising 30.5 mass % to 31.5 mass % of R.

6. The rare-earth sintered magnet of claim 1, comprising 4.5 mass % to 5.0 mass % of Tb.

7. The rare-earth sintered magnet of claim 1, comprising 0.94 mass % to 1.06 mass % of B.

8. The rare-earth sintered magnet of claim 1, comprising at most 0.25 mass % of oxygen.

9. The rare-earth sintered magnet of claim 1, comprising at most 0.10 mass % of carbon.

10. The rare-earth sintered magnet of claim 1, wherein R includes 4.5 mass % to 5.0 mass % of Tb, and the balance of R includes Nd and at least one of the rare-earth elements other than Tb and Nd as inevitably contained impurities.

11. A method for producing a rare-earth sintered magnet, the method comprising the steps of:
melting and casting a material metal or alloy to obtain alloy cast flakes;
pulverizing the alloy cast flakes to make a coarsely pulverized powder;
subjecting the coarsely pulverized powder to a jet mill pulverization process within an inert gas atmosphere including 200 ppm or less of oxygen, thereby making a finely pulverized powder; and
compacting the finely pulverized powder under a magnetic field and then subjecting a resultant green compact to a sintering process and a heat treatment, thereby obtaining a rare-earth sintered magnet,
wherein the rare-earth sintered magnet includes:
28.5 mass % to 32.0 mass % of R, which includes 3.2 mass % to 5.2 mass % of Tb and at least one of the other rare-earth elements;
0.91 mass % to 1.15 mass % of B;
at most 0.35 mass % of oxygen; and
Fe with or without Co and inevitably contained impurities as the balance, and
wherein the magnet has a remanence Bᵣ of at least 1.29 T, a coercivity H_{cJ} of at least 2.4 MA/m and a maximum energy product (BH)ₘₐₓ of at least 320 kJ/m³.

12. The method of claim 11, wherein the finely pulverized powder has a mean particle size of 2.0 μm to 2.7 μm.

13. The method of claim 11, wherein the step of compacting the finely pulverized powder includes applying a pulse magnetic field with a strength of 2.0 T or more.

14. The method of claim 11, wherein the step of compacting includes loading a mold with the finely pulverized powder, sealing the mold, aligning the powder with a magnetic field applied thereto, and then subjecting the powder to a cold isostatic pressing process.

15. The method of claim 14, wherein the step of aligning includes aligning the powder with a pulse magnetic field with a strength of 2.0 T or more.
